(19) United States
(12) Patent Application Publication
(10) Pub. No.: US 2016/0274930 A1
(43) Pub. Date: Sep. 22, 2016

(54) METHOD AND APPARATUS FOR AN ON-PROCESS MIGRATION IN A VIRTUAL ENVIRONMENT WITHIN AN INDUSTRIAL PROCESS CONTROL AND AUTOMATION SYSTEM

(71) Applicant: Honeywell International Inc., Morris Plains, NJ (US)

(72) Inventors: Prakash Mani, Bangalore (IN); Ellen B. Hawkinson, Phoenix, AZ (US); Chaitanya Sri Krishna Gunda, Kurnool (IN)

(21) Appl. No.: 14/871,898

(22) Filed: Sep. 30, 2015

Related U.S. Application Data
(60) Provisional application No. 62/133,731, filed on Mar. 16, 2015.

(51) Int. Cl. G06F 9/455; G05B 19/418

(52) U.S. Cl. CPC G06F 9/45558; G05B 19/41885; G05B 2219/42058; G06F 2009/4557; G06F 2009/45595

(57) ABSTRACT

A method is provided. The method includes installing a new release software onto a virtual machine server. The method also includes performing a replacement of a first device already installed within an industrial process control and automation system with the virtual machine server. The method further includes converting the virtual machine server into a physical machine, the physical machine comprising one of (i) the first device or (ii) a second device installed or to be installed within the industrial process control and automation system.

### CROSS-REFERENCE TO RELATED APPLICATION AND PRIORITY CLAIM

This application claims priority under 35 U.S.C. §119(e) to U.S. Provisional Patent Application No. 62/133,731 filed on Mar. 16, 2015. This provisional patent application is hereby incorporated by reference in its entirety into this disclosure.

### COPYRIGHT NOTICE

A portion of the disclosure of this patent document contains material that is subject to copyright protection. The copyright owner has no objection to the facsimile reproduction by anyone of this patent disclosure as it appears in the U.S. Patent and Trademark Office patent files or records but otherwise reserves all copyright rights.

### TECHNICAL FIELD

This disclosure relates generally to industrial process control and automation systems. More specifically, this disclosure relates to on-process migration in a virtual environment within an industrial process control and automation system.

### BACKGROUND

Industrial process control and automation systems are often used to automate large and complex industrial processes. These types of systems routinely include sensors, actuators, and controllers. The controllers typically receive measurements from the sensors and generate control signals for the actuators. The migration of software executed within a control and automation system typically involves moving from one version of the software to another version of the software. Often times, current migration processes used for industrial process control software are complex and can expose an industrial facility to increased risks during the transition. This can affect or impact various customers and decrease adoption of newer process control software.

### SUMMARY

This disclosure provides an apparatus and method for on-process migration in a virtual environment within an industrial process control and automation system.

In a first embodiment, a method is provided. The method includes installing a new release software onto a virtual machine server. The method also includes performing a replacement of a first device already installed within an industrial process control and automation system with the virtual machine server. The method further includes converting the virtual machine server into a physical machine, the physical machine comprising one of (i) the first device or (ii) a second device installed or to be installed within the industrial process control and automation system.

In a second embodiment, an apparatus is provided. The apparatus includes processing circuitry. The processing circuitry is configured to install a new release software onto a virtual machine server. The processing circuitry is also configured to perform a replacement of a first device already installed within an industrial process control and automation system with the virtual machine server. The processing circuitry is further configured to convert the virtual machine server into a physical machine, the physical machine comprising one of (i) the first device or (ii) a second device installed or to be installed within the industrial process control and automation system.

In a third embodiment, a non-transitory, computer-readable medium is provided. The non-transitory, computer-readable medium includes instructions that when executed cause at least one processing device to install a new release software onto a virtual machine server. The instructions when executed also cause the at least one processing device to perform a replacement of a first device already installed within an industrial process control and automation system with the virtual machine server. The instructions when executed further cause the at least one processing device to convert the virtual machine server into a physical machine, the physical machine comprising one of (i) the first device or (ii) a second device installed or to be installed within the industrial process control and automation system.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example process for on-process migration in a virtual environment within an industrial process control and automation system according to this disclosure;

FIG. 3 illustrates an example of how optimized on-process migration (OOPM) with EXPERION VIRTUALIZATION® project fits in a distributed control systems (DCS) environment according to this disclosure;

FIG. 4 illustrates an example system implementing a high-level migration according to this disclosure;

FIG. 5 illustrates an example system implementing an EXPERION® Support and Maintenance (ESM) migration according to this disclosure;

FIG. 6 illustrates an example migration process according to this disclosure;

FIG. 7 illustrates an example system topology according to this disclosure;

FIG. 8 illustrates an example process implemented by an ESM server in a central engineering system according to this disclosure;

FIG. 9 illustrates an example OOPM system according to this disclosure;

FIG. 10 illustrates an example ESXi management host that is in communication with an L3/L3.5 management network according to this disclosure;

FIG. 11 illustrates an example ESXi management host that is in communication with an L2 management network according to this disclosure;

FIG. 12 illustrates an example migration process with EXPERION® Virtual Template according to this disclosure;

FIG. 13 illustrates an example migration process with OS Virtual Template according to this disclosure;

FIG. 14 is an example OPM method in a virtualized environment according this disclosure;

FIG. 15 is an example virtualized environment to implement the OPM method according to this disclosure;

FIG. 16 illustrates an example method of restoring EXPERION® nodes according to this disclosure; and

FIG. 17 illustrates an example electronic device according to this disclosure.

### DETAILED DESCRIPTION

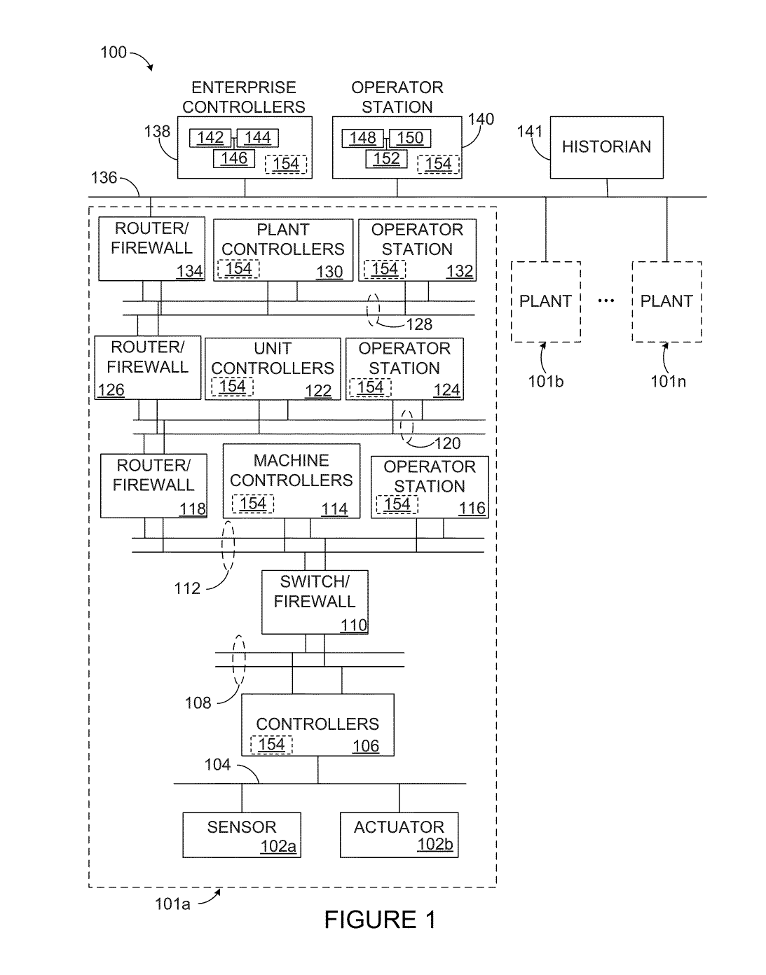

FIGS. 1 through 17, discussed herein, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers could include one or more processing devices 142 and one or more memories 144 for storing instructions and data used, generated, or collected by the processing device(s) 142. Each of the controllers could also include at least one network interface 146, such as one or more Ethernet interfaces or wireless transceivers. Also, each of the operator stations could include one or more processing devices 148 and one or more memories 150 for storing instructions and data used, generated, or collected by the processing device(s) 148. Each of the operator stations could also include at least one network interface 152, such as one or more Ethernet interfaces or wireless transceivers.

As described herein, the migration of software executed within an industrial process control and automation system (such as software executed on various controllers, operator stations, or other devices in FIG. 1) typically involves moving from one version of the software to another version of the software. Often times, current migration processes used for industrial process control software are complex and can expose an industrial facility to increased risks during the transition.

In accordance with this disclosure, a migration framework 154 is provided that supports a simpler migration process. As shown in FIG. 1, one or more components 154 could be incorporated into, or performed by, one or more components of the system 100. The migration framework 154 could reduce the risk of migration to be below the risk associated with a current platform (physical or virtual). Among other things, this approach can increase system availability during migration beyond that capable with current offerings and decrease the time that one or more systems have reduced functionality during a migration.

The migration framework 154 supports an optimized on-process migration (OOPM) technique with virtualization. The migration framework 154 includes or supports use of a virtual infrastructure (referred to as a “staging area”) for executing a software migration, a conversion of a migrated virtual machine to a physical machine (such as a migrated console station virtual machine that is converted into a physical console station), and an integrated set of tools for migration support and maintenance. Installation improvements available within the set of tools can be used for the on-process migration scenario in a virtual infrastructure. For example, the tool set can be enhanced to support on-process migration orchestration capabilities.

The migration framework 154 includes any suitable structure supporting on-process migration of process control software using virtualization. The migration framework 154 is implemented using hardware or a combination of hardware and software/firmware instructions. As a particular example, the migration framework 154 could be implemented using one or more computer programs executed by at least one processing device. Note that the migration framework 154 could be implemented within a device that performs other control-related functions (such as an operator station or higher-level controller) or by a stand-alone device.

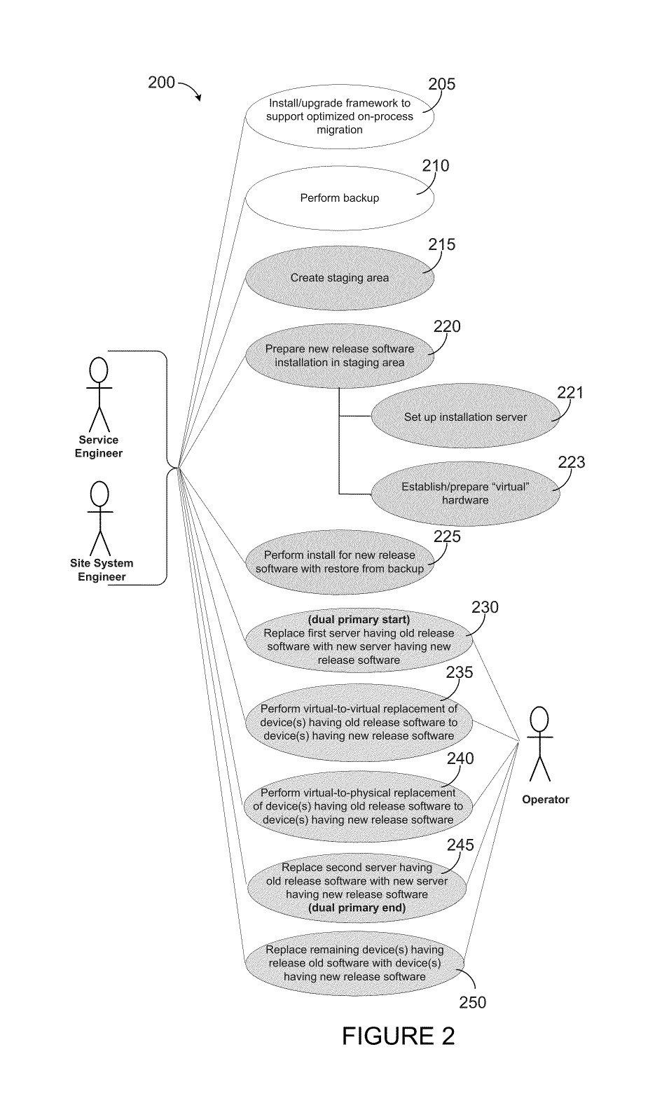

Additional details regarding the migration framework 154 are provided below with reference to FIG. 2 and in the various Appendices. Note that the details provided in the Appendices refer to a specific implementation of the migration framework 154 and that other migration frameworks 154 could be used.

Although FIG. 1 illustrates one example of an industrial process control and automation system 100, various changes may be made to FIG. 1. For example, a control system could include any number of sensors, actuators, controllers, servers, operator stations, networks, and migration frameworks. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, process control systems are highly configurable and can be configured in any suitable manner according to particular needs. In addition, while FIG. 1 illustrates one example environment in which a migration framework can be implemented, this functionality can be used in any other suitable device or system.

During complex migration between two or more industrial process control and automation system (such as EXPERION®) releases may expose a site to increased risk. Such exposure can affect distributed control system (DCS) customers who want to reduce operational costs, DCS customers who are reluctant to do an on-process migration (OPM) due to the risks and would rather just leave the plant alone, and internal HONEYWELL® groups responsible for the wall-to-wall aspects of the migration. Simpler migration operations can be utilized to reduce a site's exposure to risk below levels of both current physical platforms and current virtual platforms. Solutions as discussed herein could increase system availability (such as with normal redundancy) during migration beyond that capable with other offerings. Such solutions could also decrease time with reduced functionality (such as application control environment (ACE), Server A Flex/Console stations AAM, BMA) Such solutions could decrease time to complete a migration between releases compared to current migration times. Such solutions could further decrease the number of manual steps, decrease the amount of human intervention, decrease the amount of required OPM expertise, and increase customer confidence in achieving a successful OPM.

FIG. 2 illustrates an example process 200 for on-process migration in a virtual environment within an industrial process control and automation system according to this disclosure. For ease of explanation, the process 200 is described as being performed by the migration framework 154 in the system 100 of FIG. 1. However, the process 200 could be used within any other suitable framework and in any other suitable system.

As shown in FIG. 2, the process 200 generally includes at step 205 obtaining a framework that supports an optimized on-process migration technique. At step 210 a backup (such as a “one-click” backup) is performed to back up one or more devices associated with the control and automation system 100. At step 215, a virtualized staging area is created for the installation of new release software. At step 220, new release software is prepared in the staging area. At step 221, an installation server is set up and at step 223, “virtual” hardware is established and prepared. At step 225, the new release software is installed in the staging area and a restore of state data from the old release (such as a “one-click” restore) is performed using the backup. At this point, a service or site system engineer can verify proper operation of the new release software within the virtualized environment while the operator continues to operate the system on the old release.

Assuming the service or site system engineer wishes to continue, devices using old release software are upgraded with the new release software, or devices using the old release software are replaced with devices using the new release software at step 230. As part of this process, some devices can be upgraded or replaced virtually using a virtual-to-virtual replacement of those devices within the virtualized staging area at step 235, and then a conversion of a virtual device into a physical device can be performed for each of these devices at step 240. For example, a second device (such as a server) using old release software can be upgraded with the new release software, or a second device using the old release software can be replaced with another device using the new release software at step 245. All remaining devices using old release software can be upgraded with the new release software, or all remaining devices using the old release software can be replaced with another device using the new release software at step 250. For ease of explanation, the term “upgrade” includes an installation. An installation can be done in a staging area and subsequently transposed or transferred to a live system. It should be understood that the steps 230, 235, 240, 245, and 250 can be performed by a secondary actor.

Although FIG. 2 illustrates one example of a process 200 for on-process migration in a virtual environment within an industrial process control and automation system, various changes may be made to FIG. 2. For example, various steps shown in FIG. 2 could overlap, occur in parallel, occur in a different order, or occur any number of times.

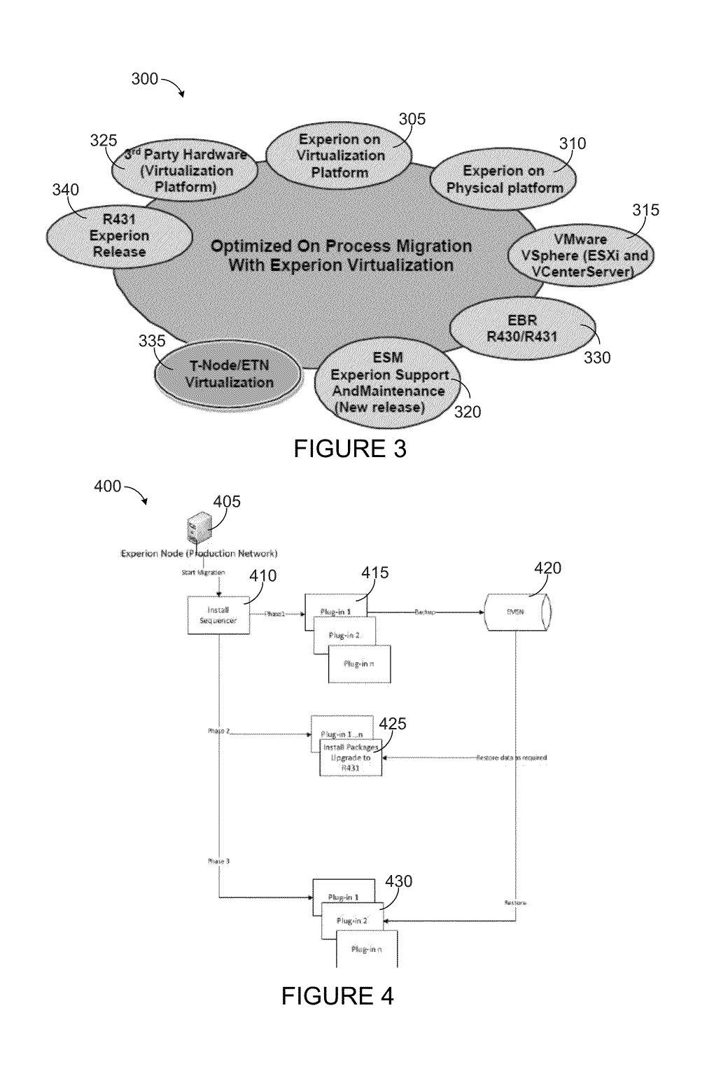

FIG. 3 illustrates an example of how an optimized OPM (OOPM) with EXPERION VIRTUALIZATION® project fits in a DCS environment according to this disclosure. This example could be used within any other suitable framework and in any other suitable system. As shown in FIG. 3, an OOPM with EXPERION VIRTUALIZATION® 300 includes an EXPERION® on virtualization platform component 305, an EXPERION® on physical platform component 310, a VMware vSphere (ESXi and vCenterServer, or the like) component 315, an EXPERION® Support and Maintenance (ESM) new release component 320, a third-party hardware (virtualization platform) component 325, an EXPERION® Backup and Restore (EBR) or R430/R431 component 330, a T-node/ETN virtualization component 335, and a R431 EXPERION® release component 340.

The EXPERION® on virtualization platform component 305 represents the set of virtual machines migrating to another EXPERION® release. Starting with R400.2, EXPERION® systems are deployed with a local storage solution. This platform could be a starting or ending platform for an OPM virtual to virtual migration. The EXPERION® on physical platform component 310 represents the physical machine migrating to another EXPERION® release. Starting with R400.x, EXPERION® systems are currently deployed on physical nodes but are moving to virtual nodes (such as physical to virtual). Starting with R400.2, EXPERION® systems are currently deployed on a virtual platform. However, not all nodes are virtualized. This set of bare metal or physical nodes is included with OOPM with the exception of T-nodes.

VMware vSphere component 315 forms the basis of a virtual infrastructure. VMware vSphere component 315 includes hypervisor, vCenterServer, Update Manager, and the like. VMware vSphere component 315 includes the functions and features available for use by OOPM. ESM new release component 320 is a standalone EXPERION® package that includes functions and features to install multiple EXPERION® nodes with a minimal amount of human interaction. ESM new release component 320 can improve the installation experience for both physical and virtual systems. ESM new release component 320 refers to a node configuration database that may exist on the EXPERION® system that a virtual machine is being migrated from. Third-party hardware component 325 includes DELL®, HP®, and IBM® server grade hosts. EBR or R430/R431 component 330 is based on Acronis 11.5 VE. EBR or R430/R431 component 330 utilizes virtual to physical conversion for the use case where a user has a partially virtualized system and wants to take advantage of OOPM improvements but is unable to justify a virtualization class of nodes (such as Flex or Console solutions).

Although FIG. 3 illustrates one example of how optimized OPM (OOPM) with EXPERION VIRTUALIZATION® project fits in a DCS environment, various changes may be made to FIG. 3. For example, the makeup and arrangement of the components illustrated in FIG. 3 could be added, omitted, combined, or placed in any other suitable configuration according to particular needs.

FIG. 4 illustrates an example system 400 implementing a high-level migration according to this disclosure. The embodiment of the system 400 illustrated in FIG. 4 is for illustration only. However, the system 400 comes in a wide variety of configurations, and FIG. 4 does not limit the scope of this disclosure to any particular implementation of the system 400.

The system 400 includes an EXPERION® node (production network) 405, an install sequencing device 410, one or more plug-ins 415, an EXPERION® management storage (EMS) node 420, one or more install packages upgraded to R431 425, and one or more plug-ins 430.

Although FIG. 4 illustrates one example of system 400, various changes may be made to FIG. 4. For example, various components in FIG. 4 could be combined, further subdivided, or omitted and additional components could be added according to particular needs.

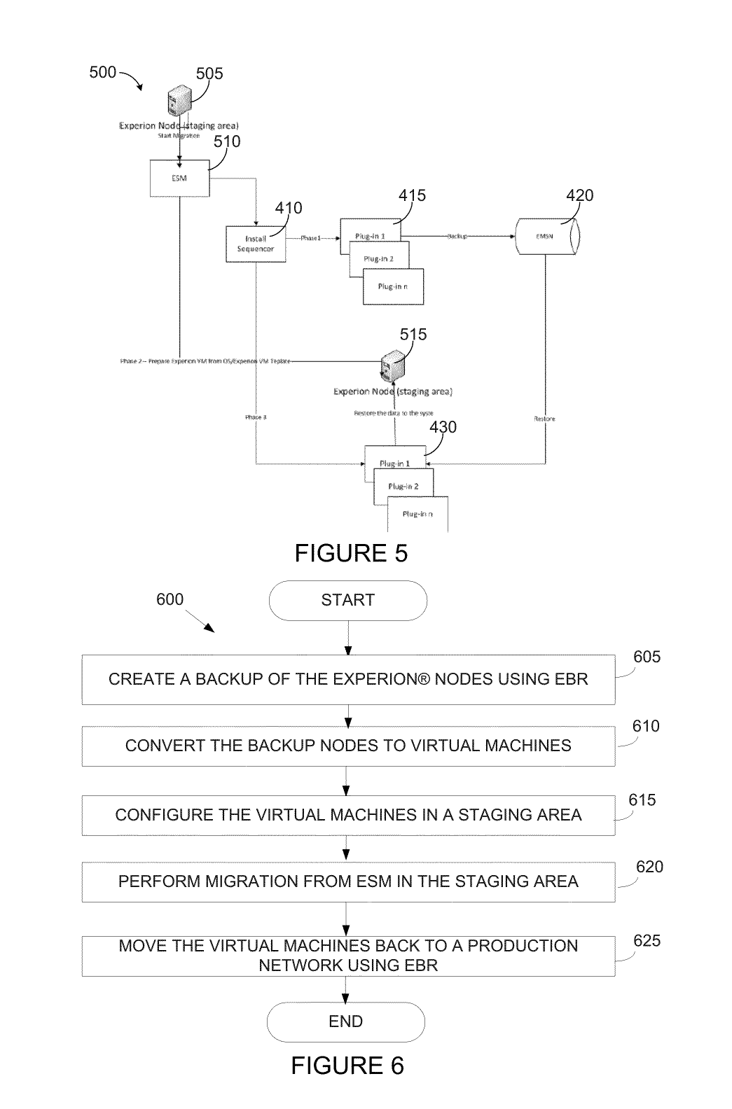

FIG. 5 illustrates an example system 500 implementing an ESM migration according to this disclosure. The embodiment of the system 500 illustrated in FIG. 5 is for illustration only. However, the system 500 comes in a wide variety of configurations, and FIG. 5 does not limit the scope of this disclosure to any particular implementation of the system 500.

The system 500 includes an EXPERION® node 505 for staging, an ESM server 510, and a second EXPERION® node 515 for staging. The system 500 also includes an install sequencing device 410, one or more plug-ins 415, an EMS node 420, and one or more plug-ins 430. FIGS. 4 and 5 are discussed in greater detail with reference to FIG. 6 described herein.

Although FIG. 5 illustrates one example of system 500, various changes may be made to FIG. 5. For example, various components in FIG. 5 could be combined, further subdivided, or omitted and additional components could be added according to particular needs.

FIG. 6 illustrates an example migration method 600 according to this disclosure. For ease of explanation, the method 600 is described as being performed in the system 400 of FIG. 4 and system 500 of FIG. 5. However, the method 600 could be used with any suitable device or system.

The migration method 600 can be used to increase system availability (such as reducing time in a dual primary state and reducing the time an ACE node is offline) during migration. At step 605, a migration framework (such as migration framework 154 from FIG. 1) creates a second or backup EXPERION® node 515 using EBR. At step 610, the migration framework converts the backup EXPERION® node to one or more virtual machines. At step 615, the migration framework configures the virtual machines in a staging area. At step 620, the migration framework performs migration from ESM in a staging area. For example, the ESM server 510 (phase 1) executes plug-ins 415 via the install sequencer 410 and backs up the EXPERION® data from the Experion Node 505 to the EMSN node 420. The ESM server 510 (phase 2) creates a new virtual machine from EXPERION® template/OS template and installs EXPERION® if the virtual machine has only OS. The ESM server 510 (phase 3) executes plug-ins 430 via the install sequencer 410 and restores the EXPERION® data from EMSN node 420 to the Experion Node 515. At step 625, the migration framework moves the virtual machines created by the EXPERION® template to the production network using EBR.

Although FIG. 6 illustrates an example migration method 600, various changes may be made to FIG. 6. For example, various steps shown in FIG. 6 could overlap, occur in parallel, occur in a different order, or occur any number of times.

FIG. 7 illustrates an example system 700 according to this disclosure. The embodiment of the system 700 illustrated in FIG. 7 is for illustration only. However, the system 700 comes in a wide variety of configurations, and FIG. 7 does not limit the scope of this disclosure to any particular implementation of the system 700.

The system 700 can be example deployment of an EXPERION® system that is virtualized. The system 700 includes an ESM server 510, one or more vSphere clients 705, one or more ESXi management hosts 710, one or more backup devices 715, an L3 EXSi production host 720, one or more management switches 725, an L3 production switch 730, an L3 router 735, one or more L2 routers 740, one or more FTE switches 745, one or more L2 ESXi production clusters 750, one or more L2 bare metal nodes 755, an L3/L3.5 management network 760, an L2 management network 762, an L3 production network 765, and one or more FTE communication lines 770. The ESM server 510 can be installed in the L3 EXSi production host 720 and can have access to the L2 management network 762. The L2 management host 710 can store EXPERION® templates, OS templates, EXPERION® Software Installation Server (ESIS) shares, and EXPERION® virtual machines.

Although FIG. 7 illustrates one example of system 700, various changes may be made to FIG. 7. For example, various components in FIG. 7 could be combined, further subdivided, or omitted and additional components could be added according to particular needs.

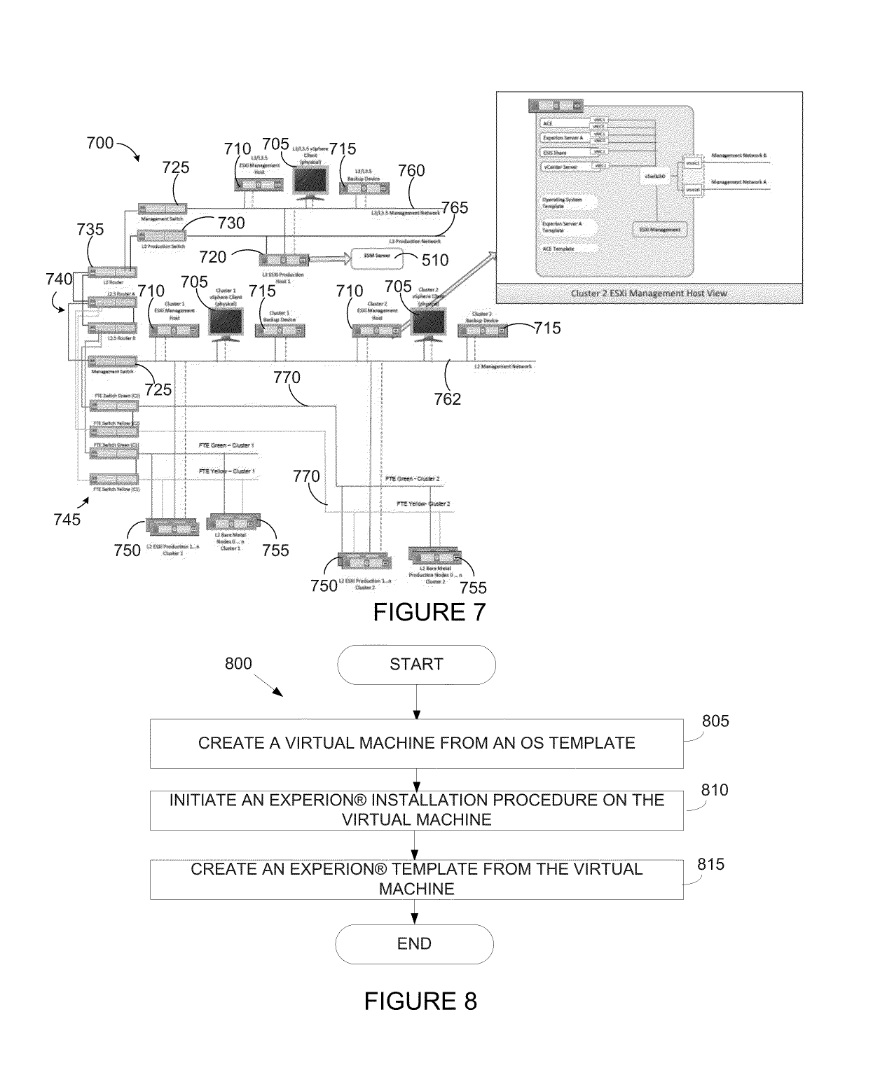

FIG. 8 illustrates an example method 800 implemented by an ESM server 510 in the central engineering system 700 according to this disclosure. The method 800 could be used with any suitable device or system.

The method 800 is implemented by the ESM server 510 on the L2 management network 762. At step 805, the ESM server 510 access an L2 management host 710 via the L2 management network 762 and creates a virtual machine from an OS template. At step 810, the ESM server 510 connects to the virtual machine, establishes a connection to ESIS share on the virtual machine, and starts an EXPERION® installation procedure on the virtual machine. At step 815, the ESM server 510 creates an EXPERION® template from the virtual machine once the EXPERION® installation procedure is completed.

Although FIG. 8 illustrates an example method 800, various changes may be made to FIG. 8. For example, various steps shown in FIG. 8 could overlap, occur in parallel, occur in a different order, or occur any number of times.

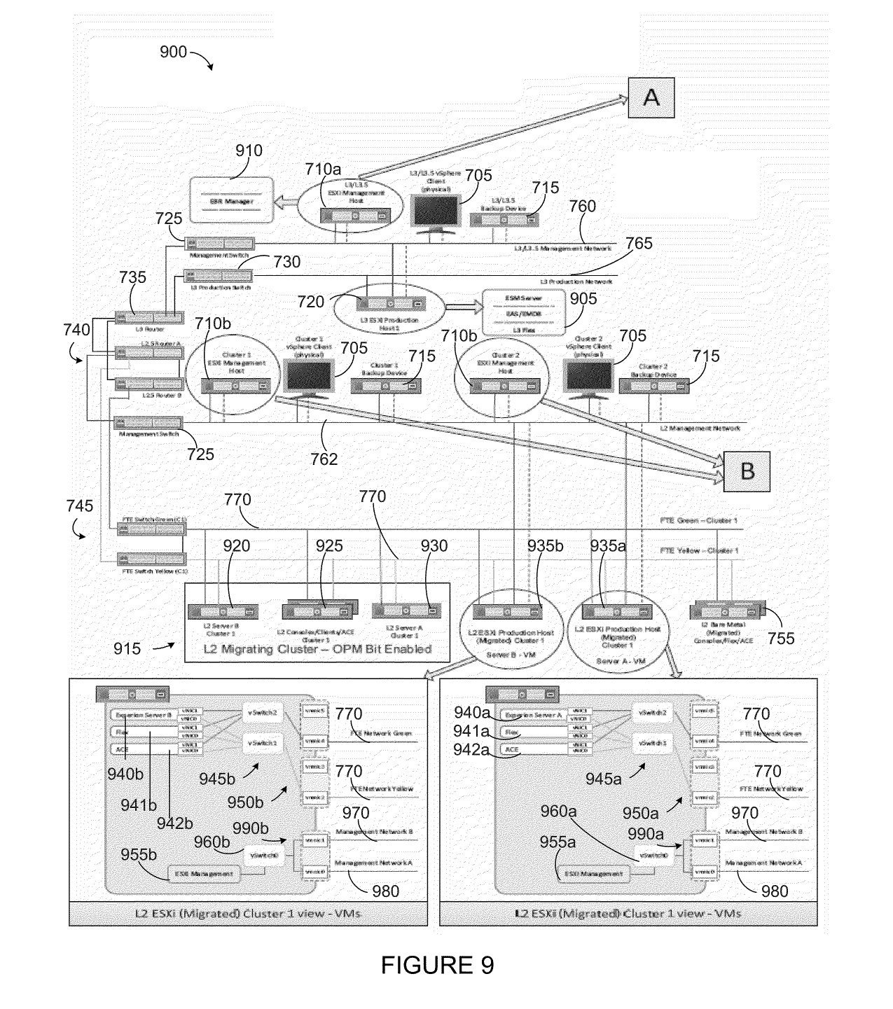

FIG. 9 illustrates an example OOPM system 900 according to this disclosure. The embodiment of the system 900 illustrated in FIG. 9 is for illustration only. However, the system 900 comes in a wide variety of configurations, and FIG. 9 does not limit the scope of this disclosure to any particular implementation of the system 900.

The OOPM system 900 includes one or more vSphere clients 705, one or more ESXi management hosts 710a and 710b, one or more backup devices 715, an L3 EXSi production host 720, one or more management switches 725, an L3 production switch 730, an L3 router 735, one or more L2 routers 740, one or more FTE switches 745, one or more L2 bare metal nodes 755, an L3/L3.5 management network 760, an L2 management network 762, an L3 production network 765, and one or more FTE communication lines 770. The OOPM system 900 also includes an ESM server/EAS/EMDB/L3 Flex device 905 and an EBR server 910. The OOPM system 900 further includes an L2 migration cluster 915. The L2 migration cluster 915 includes L2 server B cluster 920, an L2 console/clients/ACE cluster 925, and L2 server A cluster 930. The OOPM system 900 includes a first L2 ESXi Production Host cluster 935a and a second L2 ESXi Production Host cluster 935b. The first L2 ESXi Production Host cluster 935a is for the virtual machine server A. The second L2 ESXi Production Host cluster 935b is for the virtual machine server B.

The first L2 ESXi Production Host cluster 935a includes EXPERION® server A 940a, a FLEX device 941a, an ACE device 942a, one or more vSwitches 945a, and one or more virtual machine network interface cards (NICs) 950a connected to FTE communication lines 770. The first L2 ESXi Production Host cluster 935a also includes ESXi management device 955a connected to a vSwitch 960a. vSwitch 960a is connected to management network B 970 and management network A 980 via a pair of virtual machine NICs 990a. The second L2 ESXi Production Host cluster 935b includes EXPERION® server A 940b, a FLEX device 941b, an ACE device 942b, one or more vSwitches 945b, and one or more virtual machine NICs 950b connected to FTE communication lines 770. The first L2 ESXi Production Host cluster 935b also includes ESXi management device 955b connected to a vSwitch 960b. vSwitch 960b is connected to management network B 970 and management network A 980 via a pair of virtual machine NICs 990b. It should be understood that while the system 900 illustrates an example where a site is going from physical nodes to a virtualized system with physical nodes, the system 900 can also include a system that is already virtualized.

The embodiments illustrated in FIG. 9 can be implemented in many use cases. The following embodiments can all apply to performing an Experion On Process Migration in a virtualized environment as discussed herein. The following embodiment each can have different starting points with respect to the Experion platform. For example, a site may still be on a physical platform but may be planning to move to either the Essentials or Premier Experion Virtualization platform. Alternatively, a site may already be completely or partially on either the Essentials or Premier Virtualization platform. The Essentials Virtualization platform can be a lower tier platform with limited local storage. The Premier Virtualization platform can be a higher tier platform with shared storage on a blade server chassis with up to six blades.

In a first embodiment, a site can consist of several Experion R400x clusters that are ready for On-Process migration to Experion R431x or beyond. In this embodiment, the Experion platform includes physical nodes prior to performing OPM with virtualization and the Experion platform includes virtual machines after performing OPM with virtualization. All Experion nodes are deployed on physical machines that are due for a hardware refresh. The site has determined that there are costs and lifecycle benefits if all the nodes in the L2 clusters on virtual platforms are deployed.

In a second embodiment, a site can consist of several Experion R400x clusters that are ready for On-Process migration to Experion R431x or beyond except that the site determines that it will limit the scope to exclude Flex Stations or Console Stations. In this embodiment, the Experion platform includes physical nodes prior to performing OPM with virtualization and the Experion platform includes virtual machines and physical nodes after performing OPM with virtualization. These nodes will continue to be deployed on physical nodes but will be refreshed to the latest hardware platform.

In third embodiment, a site includes several Experion R400x clusters that are ready for On-Process migration to Experion R431x. In this embodiment, the Experion platform includes virtual machines prior to performing OPM with virtualization and the Experion platform includes virtual machines after performing OPM with virtualization. All Experion nodes are deployed on virtual hosts (ESXi hosts). Each ESXi host is currently running vSphere 5.1Ux.

In a fourth embodiment, a site includes several Experion R400x clusters that are ready for On-Process migration to Experion R431x except that the site currently does not deploy Flex and Console stations on the virtual platform. In this embodiment, the Experion platform includes virtual machines and physical nodes prior to performing OPM with virtualization and the Experion platform includes virtual machines and physical nodes after performing OPM with virtualization. These nodes are deployed as physical machines.

Although FIG. 9 illustrates one example of system 900, various changes may be made to FIG. 9. For example, various components in FIG. 9 could be combined, further subdivided, or omitted and additional components could be added according to particular needs.

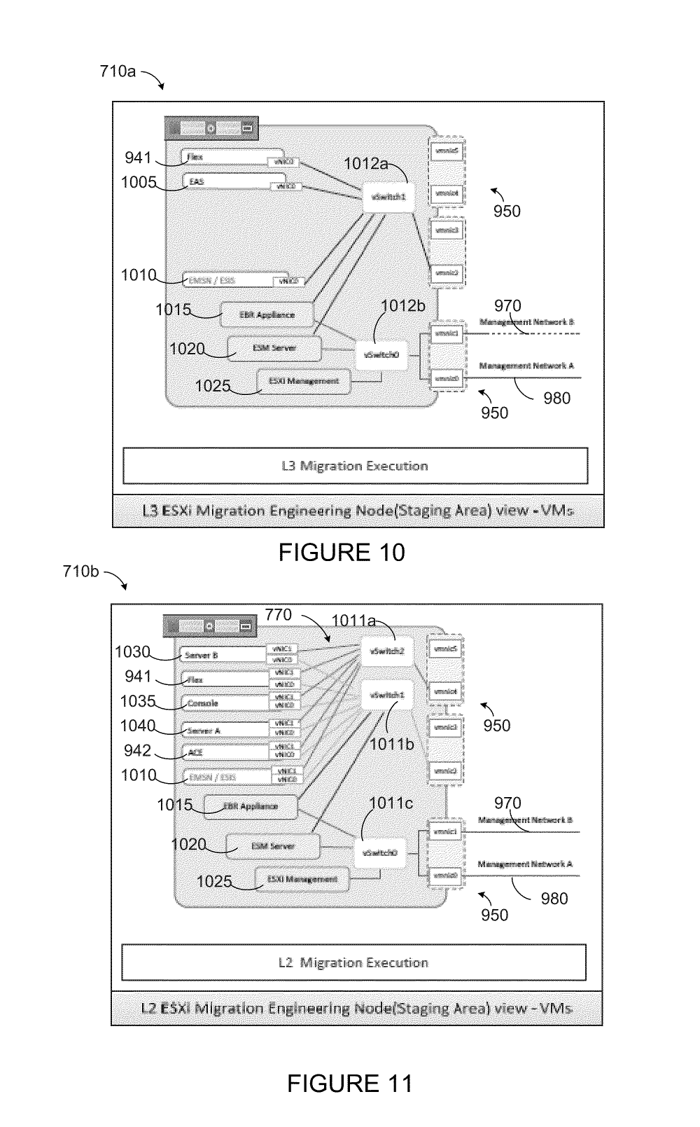

FIG. 10 illustrates an example ESXi management host 710a that is in communication with an L3/L3.5 management network 760 according to this disclosure. The embodiment of the host 710a illustrated in FIG. 10 is for illustration only. However, the host 710a comes in a wide variety of configurations, and FIG. 10 does not limit the scope of this disclosure to any particular implementation of the host 710a.

The ESXi management host 710a includes a flex device 941, an EAS device 1005, and an EMSN/ESIS device 1010 which are communicatively connected to one or more virtual machine NICs 950 via the vSwitch1 1012a. The ESXi management host 710a also includes an EBR appliance 1015, an ESM server 1020, and an ESXi management device 1025. The EBR appliance 1015 is in communication with the one or more virtual machine NICs 950 via the vSwitch1 1012a as well as the one or more virtual machine NICs 950 that are in communication with the management network B 970 and the management network A 980 via the vSwitch0 1012b. The ESM server 1020 and the ESXi management device 1025 are in communication with the one or more virtual machine NICs 950 that are in communication with the management network B 970 and the management network A 980 via the vSwitch0 1012b.

Although FIG. 10 illustrates one example of a host 710a, various changes may be made to FIG. 10. For example, various components in FIG. 10 could be combined, further subdivided, or omitted and additional components could be added according to particular needs.

FIG. 11 illustrates an example ESXi management host 710b that is in communication with an L2 management network 762 according to this disclosure. The embodiment of the host 710b illustrated in FIG. 11 is for illustration only. However, the host 710b comes in a wide variety of configurations, and FIG. 11 does not limit the scope of this disclosure to any particular implementation of the host 710b.

The ESXi management host 710b includes a server B 1030, a flex device 941, a console 1035, a server A 1040, an ACE 942, and an EMSN/ESIS device 1010, which are communicatively connected to one or more virtual machine NICs 950 via vSwitch2 1011a and vSwitch1 1011b using FTE communication lines 770. The ESXi management host 710b also includes an EBR appliance 1015, an ESM server 1020, and an ESXi management device 1025. The EBR appliance 1015 and the ESM server 1020 are in communication with the one or more virtual machine NICs 950 via the vSwitch1 1011b as well as the one or more virtual machine NICs 950 that are in communication with the management network B 970 and the management network A 980 via the vSwitch0 1011c. The ESXi management device 1025 is in communication with the one or more virtual machine NICs 950 that are in communication with the management network B 970 and the management network A 980 via the vSwitch0 1011c.

Although FIG. 11 illustrates one example of a host 710b, various changes may be made to FIG. 11. For example, various components in FIG. 11 could be combined, further subdivided, or omitted and additional components could be added according to particular needs.

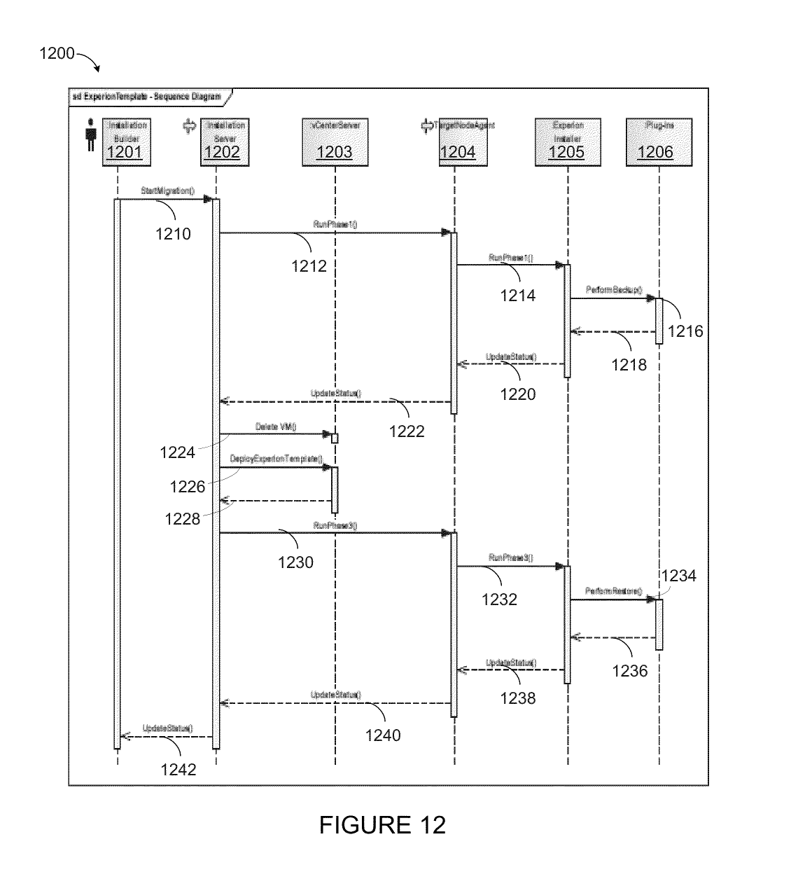

FIG. 12 illustrates an example migration method 1200 with EXPERION® Virtual Template according to this disclosure. The method 1200 could be used with any suitable device or system. At step 1210, an installation builder 1201 transmits a start migration command to an installation server 1202. At step 1212, the installation server 1202 transmits a run phase 1 command via a center server 1203 to a target node agent 1204. At step 1214, the target node agent 1204 transmits the run phase 1 command to an EXPERION® installer 1205. At step 1216, the EXPERION® installer 1205 transmits a perform backup command to one or more plug-ins 1206. At step 1218, the plug-ins 1206 transmit an acknowledgment to the EXPERION® installer 1205. At step 1220, the EXPERION® installer 1205 transmits an update status command to the target node agent 1204. At step 1222, the target node agent 1204 transmits the update status command to the installation server 1202 via the center server 1203. At step 1224, the installation server 1202 transmits a delete virtual machine command to the center server 1203. At step 1226, the installation server 1202 transmits a deploy EXPERION® Template command to the center server 1203. At step 1228, the center server 1203 transmits a deploy EXPERION® Template acknowledgment command to the installation server 1202. At step 1230, the installation server 1202 transmits a run phase 3 command to the target node agent 1204 via the center server 1203. At step 1232, the target node agent 1204 transmits the run phase 3 command to the EXPERION® installer 1205. At step 1234, the EXPERION® installer 1205 transmits a perform restore command to the plug-ins 1206. At step 1236, the plug-ins 1206 transmit a second acknowledgment to the EXPERION® installer 1205. At step 1238, the EXPERION® installer 1205 transmits a second update status command to the target node agent 1204. At step 1240, the target node agent 1204 transmits the second update status command to the installation server 1202 via the center server 1203. At step 1242, the installation server 1202 transmits the second update status command to the installation builder 1201.

Although FIG. 12 illustrates an example migration method 1200, various changes may be made to FIG. 12. For example, various steps shown in FIG. 12 could overlap, occur in parallel, occur in a different order, or occur any number of times.

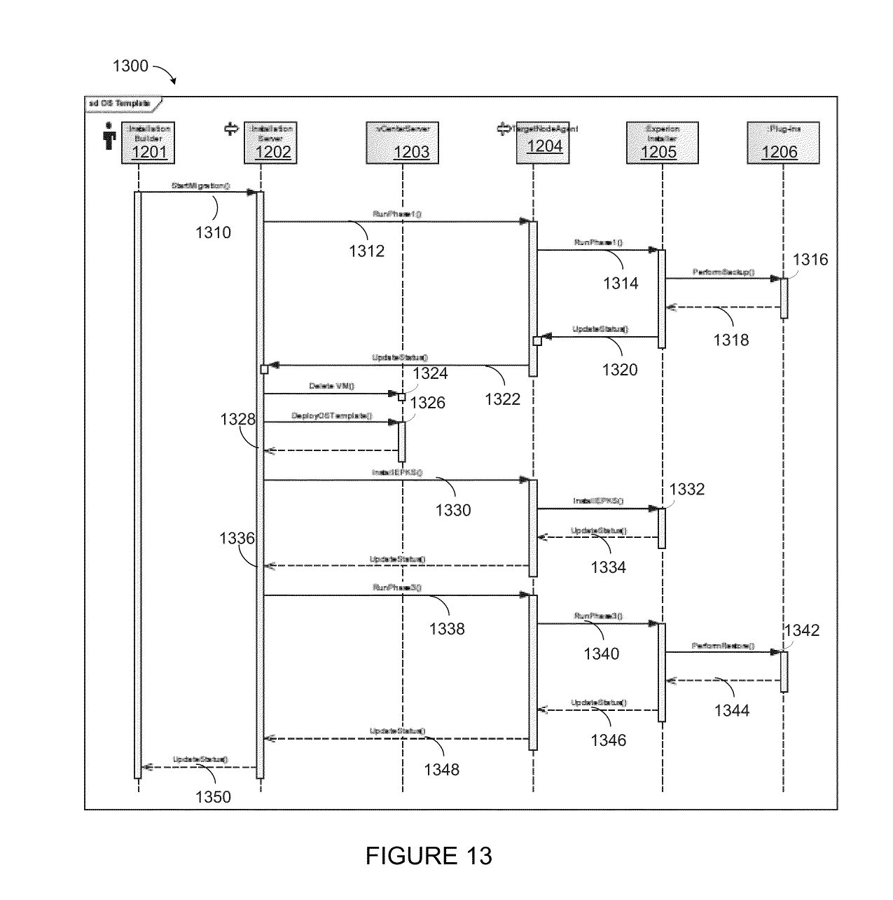

FIG. 13 illustrates an example migration method 1300 with OS Virtual Template according to this disclosure. The method 1300 could be used with any suitable device or system. At step 1310, an installation builder 1201 transmits a start migration command to an installation server 1202. At step 1312, the installation server 1202 transmits a run phase 1 command via the center server 1203 to a target node agent 1204. At step 1314, the target node agent 1204 transmits the run phase 1 command to an EXPERION® installer 1205. At step 1316, the EXPERION® installer 1205 transmits a perform backup command to one or more plug-ins 1206. At step 1318, the plug-ins 1206 transmit an acknowledgment to the EXPERION® installer 1205. At step 1320, the EXPERION® installer 1205 transmits an update status command to the target node agent 1204. At step 1322, the target node agent 1204 transmits the update status command to the installation server 1202 via the center server 1203. At step 1324, the installation server 1202 transmits a delete virtual machine command to the center server 1203. At step 1326, the installation server 1202 transmits a deploy EXPERION® Template command to the center server 1203. At step 1328, the center server 1203 transmits a deploy EXPERION® Template acknowledgment command to the installation server 1202. At step 1330, the installation server 1202 transmits an install EPKS command via the center server 1203 to the target node agent 1204. At step 1332, the target node agent 1204 transmits the install EPKS command to the EXPERION® installer 1205. At step 1334, the EXPERION® installer 1205 transmits a second update status command to the target node agent 1204. At step 1336, the target node agent 1204 transmits the second update status command to the installation server 1202 via the center server 1203. At step 1338, the installation server 1202 transmits a run phase 3 command to the target node agent 1204 via the center server 1203. At step 1340, the target node agent 1204 transmits the run phase 3 command to the EXPERION® installer 1205. At step 1342, the EXPERION® installer 1205 transmits a perform restore command to the plug-ins 1206. At step 1344, the plug-ins 1206 transmit a second acknowledgment to the EXPERION® installer 1205. At step 1346, the EXPERION® installer 1205 transmits a third update status command to the target node agent 1204. At step 1348, the target node agent 1204 transmits the third update status command to the installation server 1202 via the center server 1203. At step 1350, the installation server 1202 transmits the third update status command to the installation builder 1201.

Although FIG. 13 illustrates an example migration method 1300, various changes may be made to FIG. 13. For example, various steps shown in FIG. 13 could overlap, occur in parallel, occur in a different order, or occur any number of times.

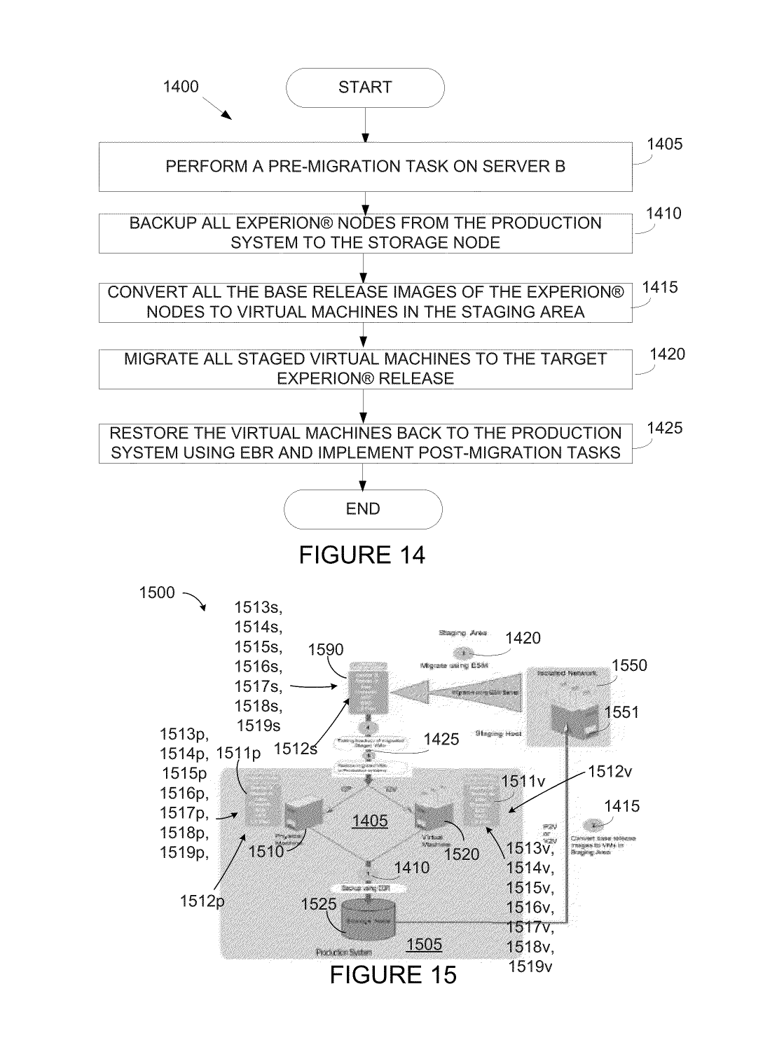

FIG. 14 is an example OPM method 1400 in a virtualized environment according this disclosure. The method 1400 could be used with any suitable device or system. FIG. 15 is an example virtualized environment 1500 to implement the OPM method 1400 according to this disclosure. The embodiment of the example virtualized environment 1500 illustrated in FIG. 15 is for illustration only. However, the example virtualized environment 1500 comes in a wide variety of configurations, and FIG. 15 does not limit the scope of this disclosure to any particular implementation of the example virtualized environment 1500.

The example virtualized environment 1500 includes production system 1505, a staging area 1550, and a migration EXPERION® cluster 1590. The production system 1505 includes a physical storage server 1510 and a virtual machine 1520. Each of the physical storage server 1510 and the virtual machine 1520 includes one or more nodes 1512p and 1512v, respectively, such as EXPERION® cluster nodes. The EXPERION® cluster nodes 1512p can include a server B device 1513p, a server A device 1514p, a flex device 1515p, a console 1516p, an ACE device 1517p, an EAS device 1518p, and L3 flex device 1519p. The EXPERION® cluster nodes 1512v can include a server B device 1513v, a server A device 1514v, a flex device 1515v, a console 1516v, an ACE device 1517v, an EAS device 1518v, and L3 flex device 1519v. The production system 1505 also includes a storage node 1525. The staging area 1550 includes an isolated network 1551. The staging area 1550 is an ESXi host on which the actual EXPERION® migration is performed. The migration EXPERION® cluster 1590 includes one or more nodes 1512s. The nodes 1512s can be considered nodes of the staging area 1550. The nodes 1512s include, for example, a server B device 1513s, a server A device 1514s, a flex device 1515s, a console 1516s, an ACE device 1517s, an EAS device 1518s, and L3 flex device 1519s.

At step 1405, pre-migration tasks are performed on server B devices 1511p and 1511v. At step 1410, the physical storage server 1510 and the virtual machine 1520 are backed up using an EBR manager at the storage node 1525. At step 1415, the base release images of the backed up physical storage server 1510 and the base release images of the virtual machine 1520 in the storage node 1525 are converted to staged virtual machines in a staging area. The base release images of the physical storage server 1510 are converted to staged virtual machine using physical machine to virtual machine (P2V) conversion. The base release images of the virtual machine 1520 are converted to staged virtual machine using virtual machine to virtual machine (V2V) conversion. The staged virtual machines are transmitted to the staging area 1550.

At step 1420, the staged virtual machines are migrated using ESM to the target EXPERION® release. The migration of the staged virtual machines to the target EXPERION® release can be performed after all of the EXPERION® nodes 1512p and 1512v are converted to staged virtual machines. At step 1425, after all of the staged virtual machines are migrated to the target EXPERION® release, the staged virtual machines are restored back to the production system 1505 using EBR. This involves either virtual to physical (V2P) or virtual to virtual (V2V) conversion. After the migrated virtual machines are restored back to the production system 1505, post-migration tasks are implemented on all the migrated EXPERION® nodes 1512p and 1512v in the production system 1505.

Although FIG. 14 illustrates an example method 1400, various changes may be made to FIG. 14. For example, various steps shown in FIG. 14 could overlap, occur in parallel, occur in a different order, or occur any number of times. Also, although FIG. 15 illustrates one example virtualized environment 1500, various changes may be made to FIG. 15. For example, various components in FIG. 15 could be combined, further subdivided, or omitted and additional components could be added according to particular needs.

In an embodiment, before the example OPM method 1400 is implemented, an EBR virtual appliance is installed on all EXPERION® nodes 1512p, 1512v, and 1512s. The EBR virtual appliance is installed on both the production system 1505 and the staging area 1550 when the production system 1505 is at least partially deployed on a virtual platform. The EBR virtual appliance is install only on the production system 1505 when the production system 1505 is deployed in the physical platform.

In an embodiment, restoring the migrated virtual machines to the production system as shown in step 1425 of FIG. 14 includes restoring the EXPERION® nodes 1512p and 1512v.

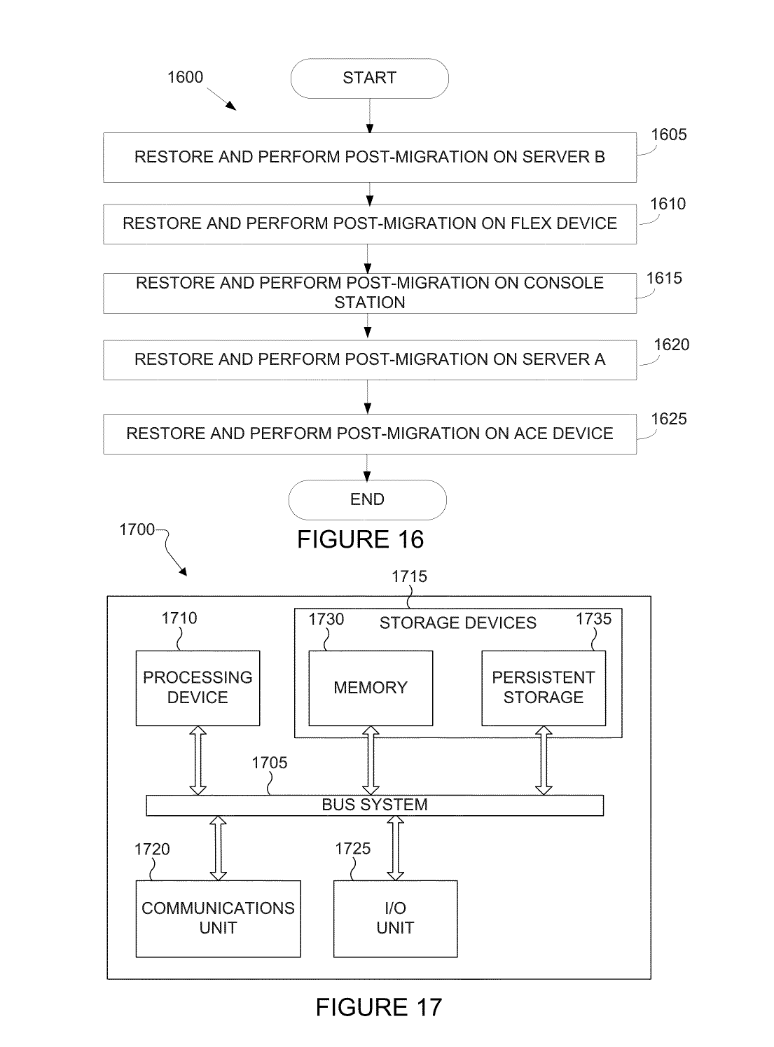

FIG. 16 illustrates an example method 1600 of restoring EXPERION® nodes 1512p and 1512v according to this disclosure. The method 1600 could be used with any suitable device or system. At step 1605, server B devices 1513v and 1513p are restored and the post-migration process is performed on server B devices 1513v and 1513p. At step 1610, the flex devices 1515v and 1515p are restored and the post-migration process is performed on flex devices 1515v and 1515p. At step 1615, the consoles 1516v and 1516p are restored and the post-migration process is performed on the consoles 1516v and 1516p. At step 1620, the server A devices 1514v and 1514p are restored and the post-migration process is performed on the server A devices 1514v and 1514p. At step 1625, the ACE devices 1518v and 1518p are restored and the post-migration process is performed on the ACE devices 1518v and 1518p. In an embodiment, the steps 1605, 1610, 1615, 1620, and 1625 are performed in the sequential numerical order. In other embodiments, various steps could overlap, occur in parallel, occur in a different order, or occur any number of times. Although FIG. 16 illustrates an example method 1600, various changes may be made to FIG. 16 without departing from the scope of this disclosure.

FIG. 17 illustrates an example electronic device 1700 according to this disclosure. The electronic device 1700 could, for example, represent the physical storage server 1510, virtual machine 1520, or any other storage or processing device as disclosed herein. As shown in FIG. 17, the electronic device 1700 includes a bus system 1705, which supports communication between at least one processing device 1710, at least one storage device 1715, at least one communications unit 1720, and at least one input/output (I/O) unit 1725.

The processing device 1710 executes instructions that may be loaded into a memory 1570. The processing device 1710 may include any suitable number(s) and type(s) of processors or other devices in any suitable arrangement. Example types of processing devices 1710 include microprocessors, microcontrollers, digital signal processors, field programmable gate arrays, application specific integrated circuits, and discreet circuitry.

The memory 1730 and a persistent storage 1735 are examples of storage devices 1715, which represent any structure(s) capable of storing and facilitating retrieval of information (such as data, program code, and/or other suitable information on a temporary or permanent basis). The memory 1730 may represent a random access memory or any other suitable volatile or non-volatile storage device(s). The persistent storage 1735 may contain one or more components or devices supporting longer-term storage of data, such as a ready only memory, hard drive, Flash memory, or optical disc.

The communications unit 1720 supports communications with other systems or devices. For example, the communications unit 1720 could include a network interface card or a wireless transceiver facilitating communications over the network 105. The communications unit 1720 may support communications through any suitable physical or wireless communication link(s).

The I/O unit 1725 allows for input and output of data. For example, the I/O unit 1725 may provide a connection for user input through a keyboard, mouse, keypad, touchscreen, or other suitable input device. The I/O unit 1725 may also send output to a display, printer, or other suitable output device.

Although FIG. 17 illustrates one example of an electronic device 1500, various changes may be made to FIG. 17. For example, electronic devices come in a wide variety of configurations. The electronic device 1700 shown in FIG. 17 is meant to illustrate one example type of electronic device and does not limit this disclosure to a particular type of electronic device.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
installing a new release software onto a virtual machine server;
performing a replacement of a first device already installed within an industrial process control and automation system with the virtual machine server; and
converting the virtual machine server into a physical machine, the physical machine comprising one of (i) the first device or (ii) a second device installed or to be installed within the industrial process control and automation system.

2. The method of claim 1, wherein performing the replacement of the first device with the virtual machine server comprises:
creating a plurality of backup nodes from a plurality of nodes on the virtual machine server;
converting the backup nodes to virtual machines;
configuring the virtual machines in a staging area;
performing a migration of the virtual machines; and
moving the virtual machines back to the virtual machine server.

3. The method of claim 2, wherein converting the backup nodes to virtual machines comprises converting the backup nodes to base release images of the virtual machines.

4. The method of claim 2, wherein the migration of the virtual machines is performed via an EXPERION® support and maintenance (ESM) device.

5. The method of claim 2, wherein the virtual machines are moved back to the virtual machine server via an EXPERION® backup and recovery (EBR) component.

6. The method of claim 1, further comprising performing one or more pre-migration tasks on the virtual machine server.

7. The method of claim 1, further comprising performing one or more post-migration tasks on the virtual machine server.

8. An apparatus comprising:
processing circuitry configured to:
install a new release software onto a virtual machine server;
perform a replacement of a first device already installed within an industrial process control and automation system with the virtual machine server; and
convert the virtual machine server into a physical machine, the physical machine comprising one of (i) the first device or (ii) a second device installed or to be installed within the industrial process control and automation system.

9. The apparatus of claim 8, wherein the processing circuitry is further configured to:
create a plurality of backup nodes from a plurality of nodes on the virtual machine server;
convert the backup nodes to virtual machines;
configure the virtual machines in a staging area;
perform a migration of the virtual machines; and
move the virtual machines back to the virtual machine server.

10. The apparatus of claim 9, wherein the processing circuitry is configured to perform the migration of the virtual machines via an EXPERION® support and maintenance (ESM) device.

11. The apparatus of claim 9, wherein the processing circuitry is configured to move the virtual machines back to the virtual machine server via an EXPERION® backup and recovery (EBR) component.

12. The apparatus of claim 8, wherein the processing circuitry is configured to perform one or more pre-migration tasks on the virtual machine server.

13. The apparatus of claim 12, wherein the processing circuitry is configured to perform one or more post-migration tasks on the virtual machine server.

14. The apparatus of claim 8, wherein the processing circuitry is configured to convert the backup nodes to base release images of the virtual machines.

15. A non-transitory computer readable medium embodying a computer program, the computer program comprising instructions that when executed cause at least one processing device to:
install a new release software onto a virtual machine server;
perform a replacement of a first device already installed within an industrial process control and automation system with the virtual machine server; and
convert the virtual machine server into a physical machine, the physical machine comprising one of (i) the first device or (ii) a second device installed or to be installed within the industrial process control and automation system.

16. The non-transitory computer readable medium of claim 15, wherein the computer program further comprises instructions that when executed cause the at least one processing device to:
create a plurality of backup nodes from a plurality of nodes on the virtual machine server;
convert the backup nodes to virtual machines;
configure the virtual machines in a staging area;
perform a migration of the virtual machines; and
move the virtual machines back to the virtual machine server.

17. The non-transitory computer readable medium of claim 16, wherein the computer program further comprises instructions that when executed cause the at least one processing device to:
perform the migration of the virtual machines via an EXPERION® support and maintenance (ESM) device.

18. The non-transitory computer readable medium of claim 16, wherein the computer program further comprises instructions that when executed cause the at least one processing device to:
move the virtual machines back to the virtual machine server via an EXPERION® backup and recovery (EBR) component.

19. The non-transitory computer readable medium of claim 15, wherein the computer program further comprises instructions that when executed cause the at least one processing device to:
convert the backup nodes to base release images of the virtual machines.

20. The non-transitory computer readable medium of claim 15, wherein the computer program further comprises instructions that when executed cause the at least one processing device to:
perform one or more pre-migration tasks or post-migration tasks on the virtual machine server.
